(19) United States
(12) Patent Application Publication
(10) Pub. No.: US 2016/0257460 A1
(43) Pub. Date: Sep. 8, 2016

(54) Static Dissipating Downtube And Valve

(71) Applicant: Micro Matic USA, Inc., Brooksville, FL (US)

(72) Inventor: Michael Tomlinson, Spring Hill, FL (US)

(73) Assignee: Micro Matic USA, Inc., Brooksville, FL (US)

(21) Appl. No.: 15/061,849

(22) Filed: Mar. 4, 2016

Related U.S. Application Data
(60) Provisional application No. 62/129,502, filed on Mar. 6, 2015.

(51) Int. Cl. B65D 47/06; B05B 15/00; F16K 27/00

(52) U.S. Cl. CPC B65D 47/06; F16K 27/00; B05B 15/005

(57) ABSTRACT

An apparatus for dispensing liquid from a container and that dissipates static charge is provided. The apparatus may include a valve configured to be coupled to an opening in the container, and a downtube coupled to the valve. The downtube may be configured to accommodate flow of the liquid and pass the liquid to the valve. At least one of the valve and downtube may be made of an electrically conductive plastic material to facilitate dissipation of static charge.

### CROSS-REFERENCE TO RELATED APPLICATION

This application claims the benefit of U.S. Provisional Patent Application No. 62/129,502, filed on Mar. 6, 2015, which is incorporated herein by reference in its entirety.

### TECHNICAL FIELD

The exemplary embodiments disclosed herein relate generally to a downtube and valve used in dispensing liquids from a container, and more specifically to a downtube and valve that dispenses liquid from a container while also dissipating static charge that may build up on the surface of the downtube.

### SUMMARY

In the container industry, “closed” systems are used for various applications, such as filling and dispensing potentially harmful liquids without exposing people using the container to the liquid contents. As shown in FIG. 2, to draw liquid from the base of a sealed container, a valve is secured at the top of the container, and a plastic downtube is secured at one end to the valve and the other end extends to the base of the container. When liquids flow through a non-conductive material, such as a plastic downtube, a static charge can build up on the surface of the material. If the liquid is flammable, an arc of static charge can cause the liquid to ignite. Thus, the static charge must be dissipated before it accumulates to the point where it can form an arc.

Moreover, after a static charge is built up, when the container is connected to pumping equipment to draw the fluid out of it, an arc can occur if the pumping equipment is at a different potential. The equipment must be bonded to the fluid and allowed to stabilize at the same potential before connecting to the valve. However, if either or both of the valve and downtube are non-conductive plastic, they may not readily stabilize.

One way to address this issue is to use a conductive material for the container, such as steel, which dissipates the charge when plastic valves and/or downtubes are used. When bonding to pumping equipment, sufficient time is allowed for any charge to creep off the surfaces of the plastic components that are either wetted or in direct contact with the steel container before connecting to the valve. With fluids of high volatility, the amount of time required to insure that all equipment is at the same potential may prove to be excessive. In addition, in some circumstances conductive materials such as steel are not feasible, for example due to expense, corrosion, or chemical compatibility. In these instances, a plastic container may be used in combination with a grounding cable that is dropped into the container to mitigate the static charge. In a sealed container, the grounding cable must be connected to a conductive element that penetrates the exterior of the container, such as a steel valve, in order to dissipate the static charge. But when a plastic valve is required, e.g., for reasons of expense, corrosion, or chemical compatibility, a separate grounding/bonding lug must be provided on the container to enable proper static dissipation. Using a separate grounding cable or grounding lug adds additional expense and manufacturing difficulty to the process of producing a container that properly dissipates static charge. In addition, if the grounding cable or grounding lug fails, the liquid can continue to be drawn out, thereby continuing to increase the static charge, without any backup measure for dissipating the static charge, and without the operator being aware of the potential arc. Accordingly, an improved apparatus for dispensing liquids from a container while dissipating static charge is needed.

According to an aspect of one or more exemplary embodiments, there is provided an apparatus for dispensing liquid from a container. The apparatus may include a valve configured to be coupled to an opening in the container, and a downtube coupled to the valve. The downtube may be configured to accommodate flow of the liquid and pass the liquid to the valve. At least one of the valve and downtube may be made of an electrically conductive plastic material.

According to one or more exemplary embodiments, the electrically conductive plastic material may be made by adding a carbon additive to a plastic material.

According to one or more exemplary embodiments, the valve may be made of steel.

According to one or more exemplary embodiments, the valve and the downtube may be made of electrically conductive plastic material.

According to one or more exemplary embodiments, the valve may be made of a first electrically conductive plastic material, and the downtube may be made of a second electrically conductive material.

According to one or more exemplary embodiments, the downtube may have an upper portion having a first width, and a lower portion having a second width. The first width may be greater than the second width.

### BRIEF DESCRIPTION OF DRAWINGS

FIG. 1 is a side view of a liquid dispensing apparatus having a static dissipating valve and downtube according to an exemplary embodiment.

FIG. 2 is a side view of a container coupled to a liquid dispensing apparatus having a static dissipating valve and downtube according to an exemplary embodiment.

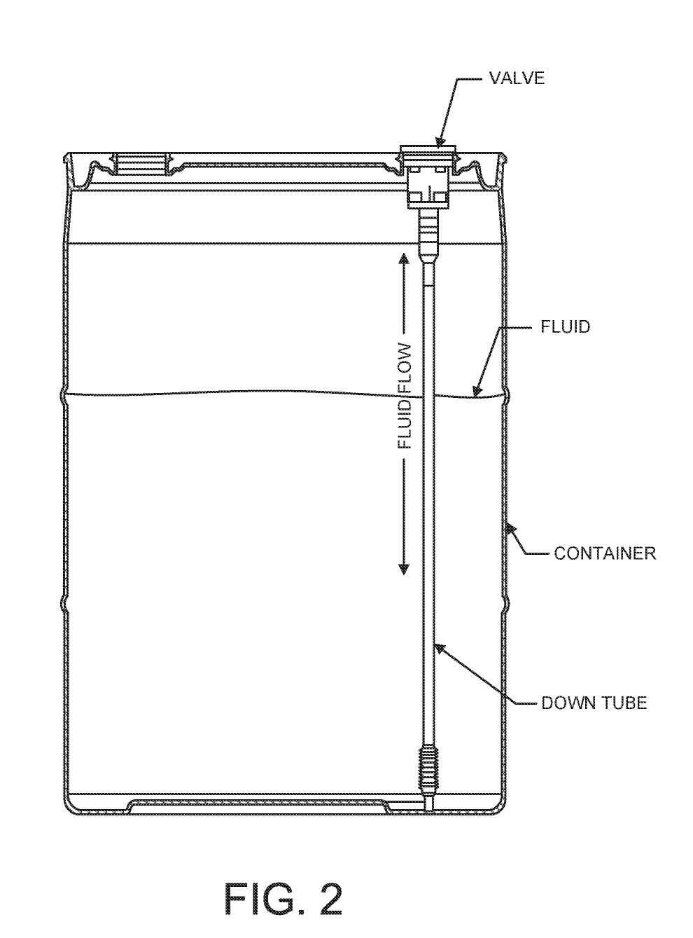

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

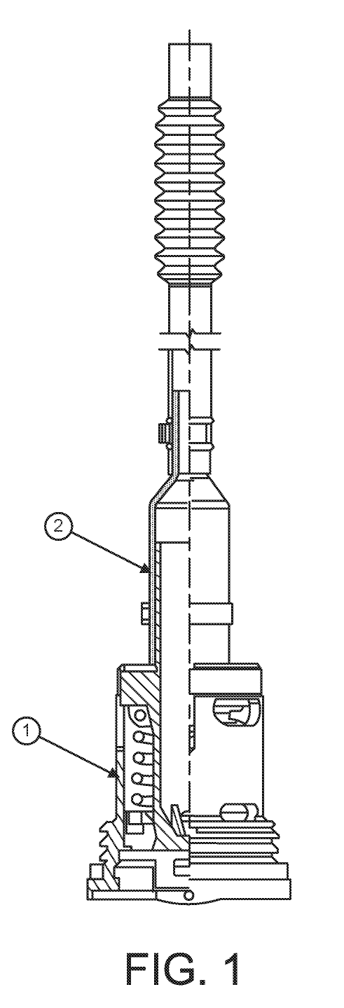

FIG. 1 illustrates a liquid dispensing apparatus according to an exemplary embodiment. Referring to FIG. 1, valve 1 is coupled to downtube 2. Downtube 2 may be made of polyethylene, polyphenylene sulfide, or other plastic material. According to an exemplary embodiment, during manufacturing of a plastic downtube and/or valve, an electrically conductive material may be added to the plastic before the downtube and/or valve is formed. For example, a carbon additive may be added to the plastic. The carbon additive renders the plastic downtube and/or valve electrically conductive. As a result, the plastic downtube and/or valve has sufficient conductivity to bleed the static charge out of the container. Although carbon may be added to the plastic to make the downtube and/or valve electrically conductive, other electrically conductive material may be added instead of or in addition to carbon.

When the electrically conductive plastic downtube is connected to a steel valve, the valve can be grounded so that the static charge is dissipated at its source. Alternatively, when the electrically conductive plastic downtube is connected to a plastic valve, the plastic valve may also be made of a plastic that includes an electrically conductive material. The electrically conductive material of the valve may or may not be the same as the electrically conductive material of the downtube. In this exemplary embodiment, the static charge is bled through the plastic valve.

By using a plastic that includes an electrically conductive material, the static charge is dissipated at its source, rather than requiring the charge to migrate to a separate ground. In addition, by modifying the existing downtube and/or valve, there is no need for additional components such as a grounding wire or grounding lug. Moreover, the configurations of the exemplary embodiments provide additional safety advantages in the event the grounding component fails. In the exemplary embodiments disclosed above, if the grounding component (i.e., the downtube or valve) fails, the flow of liquid stops and no additional static charge is generated. By contrast, when using a grounding wire or grounding lug, if either component fails, the downtube and valve will continue allowing liquid to be drawn up, thus continuing the accumulation of static charge without any way of dissipating the charge. Accordingly, the exemplary embodiments discussed herein provide significant safety advantages.

Although the inventive concepts of the present disclosure have been described and illustrated with respect to exemplary embodiments thereof, it is not limited to the exemplary embodiments disclosed herein and modifications may be made therein without departing from the scope of the inventive concepts.

What is claimed is:

1. An apparatus for dispensing a liquid from a container, the apparatus comprising:
a valve configured to be coupled to an opening in the container; and
a downtube coupled to the valve;
wherein the downtube is configured to accommodate flow of the liquid and pass the liquid to the valve; and
wherein at least one of the valve and downtube is made of an electrically conductive plastic material.

2. The apparatus of claim 1, wherein the electrically conductive plastic material is made adding a carbon additive to a plastic material.

3. The apparatus of claim 2, wherein the valve is made of steel.

4. The apparatus of claim 2, wherein the valve and the downtube are made of the electrically conductive plastic material.

5. The apparatus of claim 2, wherein the valve is made of a first electrically conductive plastic material, and the downtube is made of a second electrically conductive material.

6. The apparatus of claim 1, wherein the downtube comprises an upper portion having a first width, and a lower portion having a second width;
wherein the first width is greater than the second width.
